(19) United States
(12) Patent Application Publication
(10) Pub. No.: US 2009/0262118 A1
(43) Pub. Date: Oct. 22, 2009

(54) METHOD, SYSTEM AND STORAGE DEVICE FOR CREATING, MANIPULATING AND TRANSFORMING ANIMATION

(76) Inventors: Okan Arikan, Mountain View, CA (US); Leslie Ikemoto, Mountain View, CA (US)

Correspondence Address: HULSEY IP INTELLECTUAL PROPERTY LAWYERS, P.C., 919 Congress Avenue, Suite 919, AUSTIN, TX, 78701, US

(21) Appl. No.: 12/424,012

(22) Filed: Apr. 15, 2009

Related U.S. Application Data
(60) Provisional application No. 61/047,009, filed on Apr. 22, 2008.

(51) Int. Cl. G06T 15/70

(52) U.S. Cl. 345/473

(57) ABSTRACT

An animation method, system, and storage device which takes animators submissions of characters and animations and breaks the animations into segments where discontinuities will be minimized; allows users to assemble the segments into new animations; allows users to apply modifiers to the characters; provides a semantic restraint system for virtual objects; and provides automatic character animation retargeting.

### RELATED APPLICATIONS

This application claims priority to U.S. Provisional Patent Application Ser. No. 61/047,009, filed Apr. 22, 2008 and titled “METHOD, SYSTEM AND STORAGE DEVICE FOR CREATING, MANIPULATING AND TRANSFORMING ANIMATION,” incorporated herein in its entirety.

### FIELD OF THE INVENTION

The disclosed subject matter relates primarily to systems and methods for animation.

### BACKGROUND OF THE INVENTION

The successes of YouTube™, Flickr™, and blogs have shown that people like to create and share digital content they have created. 3D digital media content appeals to users because: (a) it permits typical people to create their own reality and removes real life limitations (e.g. one can generate special effects easily); (b) it facilitates role-playing—users can be swamp monsters or elves without difficulty, expense, or personal embarrassment; and (c) 3D digital creations like avatars can anonymize the user which is especially important for keeping children safe from on-line predators.

Despite this potential, 3D digital media is underused because it is currently difficult for a typical person to work with. First, creating the assets—like the characters, environment, animation, and effects—requires a high level of skill. Second, putting the assets together into a coherent story requires advanced knowledge of professional 3D authoring packages. Even talented artists find the learning curves for these packages daunting. Because of the difficulty and expense, creating 3D movies is generally limited to specialized 3D movie studios like Pixar™ (creators of Toy Story™) and Dreamworks™ (creators of Shrek™). While many amateur filmmakers can create a live action movie, very few can currently create a 3D movie.

Animating a character involves posing it at every time sample. Characters typically have tens to hundreds of degrees of freedom that affect their pose. Time is usually sampled at 10-60 Hertz. Therefore, animating a character even for one second is difficult because it involves controlling many degrees of freedom. Typically only experts can manipulate that many controls in a way that makes the character move in a compelling fashion.

A few years ago, only trained professionals could create DVDs, on-line photo albums, and websites. Today, typical computer users can easily accomplish these tasks.

These extensive costs and learning curves associated with more traditional 3D animation severely limits its accessibility by amateurs. Further, it substantially raises the entry barriers for new 3D animation companies.

### BRIEF SUMMARY OF THE INVENTION

There is a need for a method, system, and/or storage device that allows the typical computer user to accomplish the otherwise difficult task of creating compelling 3D content.

One aspect of the disclosed subject matter is allowing users to reuse parts of existing characters and animations.

Another aspect of the disclosed subject matter is allowing users to manipulate existing character and animation parts through a simple user interface that allows the parts to be joined together to make new creations.

An additional aspect of the disclosed subject matter is allowing users to reuse parts of existing environments.

Yet another aspect of the disclosed subject matter is allowing users to manipulate existing environments through a simple user interface that allows the parts of the environments to be joined together to make new environments.

An additional aspect of the disclosed subject matter is allowing creators to submit their characters, animations, and/or environments for other users to use.

An additional aspect of the disclosed subject matter is breaking up existing animations into pieces that can later be reassembled to create new animations.

Yet another aspect of the disclosed subject matter is providing a user friendly constraint system.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGUREs and detailed description. It is intended that all such additional systems, methods, features and advantages that are included within this description, be within the scope of the claims attached.

### BRIEF DESCRIPTIONS OF THE DRAWINGS

The features, nature, and advantages of the disclosed subject matter will become more apparent from the detailed description set forth below when taken in conjunction with the accompanying drawings, wherein:

FIG. 1 illustrates a computer system and related peripherals that may operate with the job posting and matching service of the present embodiment.

FIG. 2 shows a flow chart of the segmentation process of the animation system of the present embodiment.

FIGS. 3a, 3b, and 3c show exemplary graphical representations of the steps in the segmentation process of the animation system of the present embodiment.

FIG. 4 shows a flow chart of the segmentation joining process of the animation system of the present embodiment.

FIGS. 5a and 5b show exemplary graphical representations of the assembling a new clip of the animation system of the present embodiment.

FIG. 5c shows an exemplary graphical representation of adding a modifier to a new clip of the animation system of the present embodiment.

FIGS. 6a and 6b show exemplary graphical representations of the stabilization method of the animation system of the present embodiment.

FIGS. 7a, 7b, and 7c show exemplary graphical representations of the constraint system of the animation system of the present embodiment.

FIGS. 8a and 8b show exemplary graphical representations of editing a character's foot plants of the animation system of the present embodiment.

FIGS. 9a and 9b, show exemplary graphical representations of minimizing the orientation change in each free contact of the animation system of the present embodiment.

FIG. 10 shows a graphical representation of a character in a T-Pose of the animation system of the present embodiment.

FIGS. 11a and 11b depict graphical representations of skeletons in T-poses for the automatic character animation retargeting of the animation system of the present embodiment.

FIG. 12 shows a flow chart of the bone retargeting system of the animation system of the present embodiment.

FIGS. 13a and 13b show graphical representations of an alternative method to interpolating the rotations for bones of the animation system of the present embodiment.

### DETAILED DESCRIPTION OF ILLUSTRATIVE EMBODIMENTS

Although described with reference to specific embodiments, one skilled in the art could apply the principles discussed herein to other areas and/or embodiments. Further, one skilled in the art could apply the principles discussed herein to communication mediums beyond the Internet.

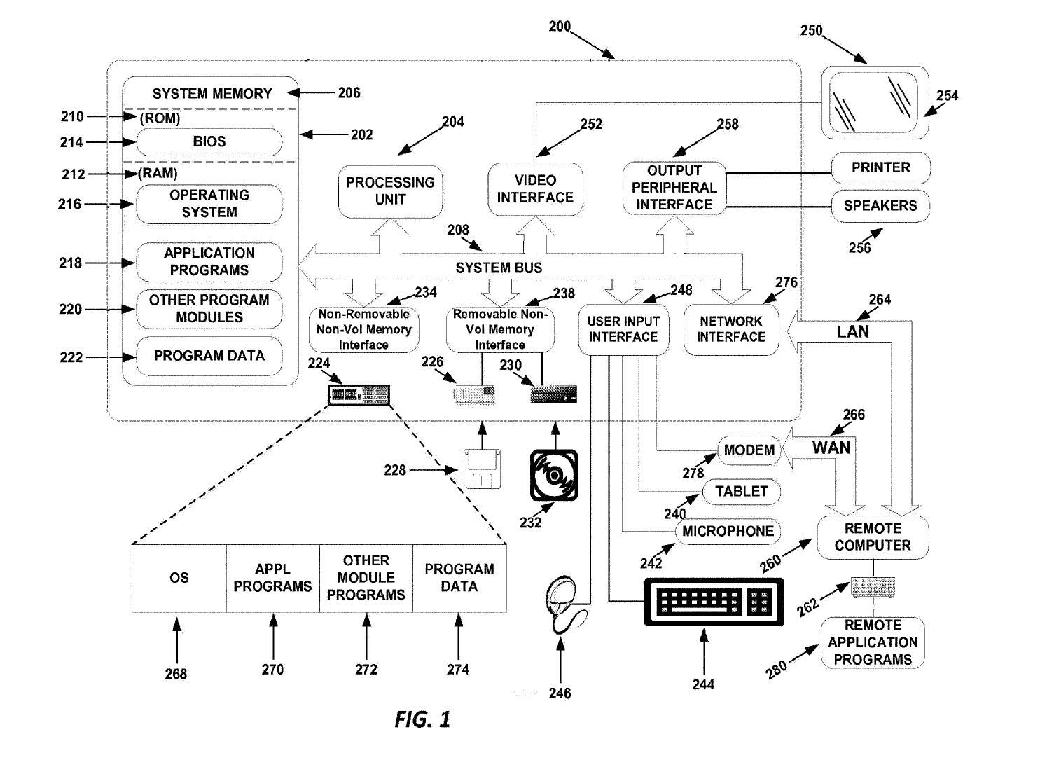

With reference to FIG. 1, an exemplary system within a computing environment for implementing the invention includes a general purpose computing device in the form of a computing system 200, commercially available from Intel, IBM, AMD, Motorola, Cyrix and others. Components of the computing system 202 may include, but are not limited to, a processing unit 204, a system memory 206, and a system bus 236 that couples various system components including the system memory to the processing unit 204. The system bus 236 may be any of several types of bus structures including a memory bus or memory controller, a peripheral bus, and a local bus using any of a variety of bus architectures.

Computing system 200 typically includes a variety of computer readable media. Computer readable media can be any available media that can be accessed by the computing system 200 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data.

Computer memory includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing system 200.

The system memory 206 includes computer storage media in the form of volatile and/or nonvolatile memory such as read only memory (ROM) 210 and random access memory (RAM) 212. A basic input/output system 214 (BIOS), containing the basic routines that help to transfer information between elements within computing system 200, such as during start-up, is typically stored in ROM 210. RAM 212 typically contains data and/or program modules that are immediately accessible to and/or presently being operated on by processing unit 204. By way of example, and not limitation, an operating system 216, application programs 220, other program modules 220 and program data 222 are shown.

Computing system 200 may also include other removable/non-removable, volatile/nonvolatile computer storage media. By way of example only, a hard disk drive 224 that reads from or writes to non-removable, nonvolatile magnetic media, a magnetic disk drive 226 that reads from or writes to a removable, nonvolatile magnetic disk 228, and an optical disk drive 230 that reads from or writes to a removable, nonvolatile optical disk 232 such as a CD ROM or other optical media could be employed to store the invention of the present embodiment. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 224 is typically connected to the system bus 236 through a non-removable memory interface such as interface 234, and magnetic disk drive 226 and optical disk drive 230 are typically connected to the system bus 236 by a removable memory interface, such as interface 238.

The drives and their associated computer storage media, discussed above, provide storage of computer readable instructions, data structures, program modules and other data for the computing system 200. For example, hard disk drive 224 is illustrated as storing operating system 268, application programs 270, other program modules 272 and program data 274. Note that these components can either be the same as or different from operating system 216, application programs 220, other program modules 220, and program data 222. Operating system 268, application programs 270, other program modules 272, and program data 274 are given different numbers hereto illustrates that, at a minimum, they are different copies.

A user may enter commands and information into the computing system 200 through input devices such as a tablet, or electronic digitizer, 240, a microphone 242, a keyboard 244, and pointing device 246, commonly referred to as a mouse, trackball, or touch pad. These and other input devices are often connected to the processing unit 204 through a user input interface 248 that is coupled to the system bus 208, but may be connected by other interface and bus structures, such as a parallel port, game port or a universal serial bus (USB).

A monitor 250 or other type of display device is also connected to the system bus 208 via an interface, such as a video interface 252. The monitor 250 may also be integrated with a touch-screen panel or the like. Note that the monitor and/or touch screen panel can be physically coupled to a housing in which the computing system 200 is incorporated, such as in a tablet-type personal computer. In addition, computers such as the computing system 200 may also include other peripheral output devices such as speakers 254 and printer 256, which may be connected through an output peripheral interface 258 or the like.

Computing system 200 may operate in a networked environment using logical connections to one or more remote computers, such as a remote computing system 260. The remote computing system 260 may be a personal computer, a server, a router, a network PC, a peer device or other common network node, and typically includes many or all of the elements described above relative to the computing system 200, although only a memory storage device 262 has been illustrated. The logical connections depicted include a local area network (LAN) 264 connecting through network interface 276 and a wide area network (WAN) 266 connecting via modem 278, but may also include other networks. Such networking environments are commonplace in offices, enterprise-wide computer networks, intranets and the Internet.

The central processor operating pursuant to operating system software such as IBM OS/2®, Linux®, UNIX®, Microsoft Windows®, Apple Mac OSX® and other commercially available operating systems provides functionality for the services provided by the present invention. The operating system or systems may reside at a central location or distributed locations (i.e., mirrored or standalone).

Software programs or modules instruct the operating systems to perform tasks such as, but not limited to, facilitating client requests, system maintenance, security, data storage, data backup, data mining, document/report generation and algorithms. The provided functionality may be embodied directly in hardware, in a software module executed by a processor or in any combination of the two.

Furthermore, software operations may be executed, in part or wholly, by one or more servers or a client's system, via hardware, software module or any combination of the two. A software module (program or executable) may reside in RAM memory, flash memory, ROM memory, EPROM memory, EEPROM memory, registers, hard disk, a removable disk, a CD-ROM, DVD, optical disk or any other form of storage medium known in the art. An exemplary storage medium is coupled to the processor such that the processor can read information from, and write information to, the storage medium. In the alternative, the storage medium may be integral to the processor. The processor and the storage medium may also reside in an application specific integrated circuit (ASIC). The bus may be an optical or conventional bus operating pursuant to various protocols that are well known in the art.

### Character Background

A character is commonly made up of a series of joints that are associated with each other via a structure. Typically, this structure is called a skeleton. An animation clip specifies the pose the character should assume at each time sample. Throughout this disclosure, it is assumed that the character's skin (geometrical representation of the character's shape) is tied to the simpler underlying control structure—the skeleton. However, while it is common to represent a character this way, there are many other representations and the methods and systems disclosed herein may also be used with these other representations.

Creating Character Animation from Existing Pieces

Many techniques that manipulate existing character animation data use a method called motion blending to smooth over discontinuities introduced by joining two animation pieces together. For example, combining a walking animation and a running animation will likely produce a discontinuity at the join point that makes the character look like it instantly “jumped” from walking to running. Motion blending can smooth the discontinuities by spreading them over a short time period around the join point.

To minimize discontinuities, the beginning and end of each clip should be at a place in the clip where errors will be the least noticeable. Errors are least noticeable when the contact force between the character and the environment is the highest. Therefore, clips should be split at the point at which a “contact” between the character and the environment is planted most strongly. A contact between the character and the environment is best explained by example: a character's foot on the ground; a character's hand when the character is hanging from a rope; etc. To identify where the contact force is highest, the clip should be split at the point at which a contact between the character and the environment is moving the most slowly.

In addition to minimizing discontinuities, the length of the resulting segments must be addressed. Segments that are too long are undesirable because they reduce the flexibility users will ultimately have to create their animation. Conversely, segments that are too short are also undesirable because if many segments are joined together in quick succession, visual artifacts can manifest.

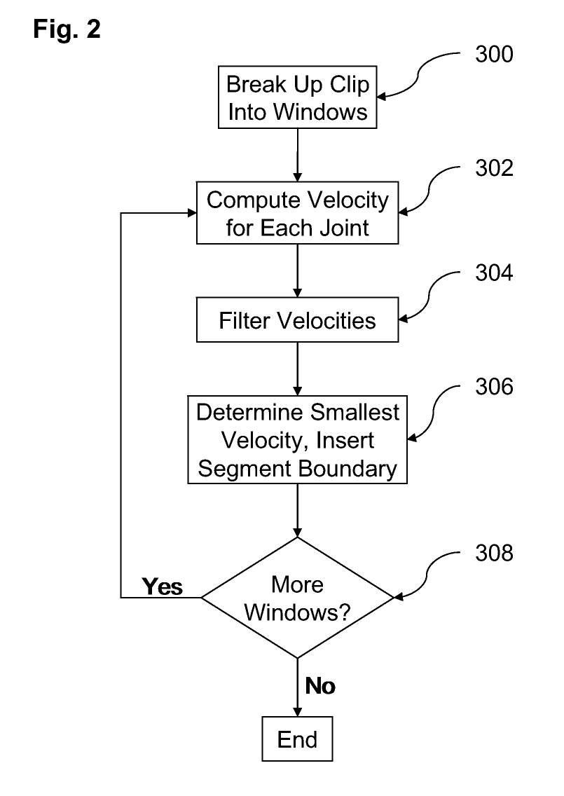

FIG. 2 shows a flow chart of the segmentation process of the animation system of the present embodiment. After an animator submits a character and an animation clip, the system then must break the animation clip into segments so each segment may be reassembled later to form a new animation clip. First, the full clip is divided into smaller windows 300. A window is just a smaller portion of the full animation clip. For example, if the window size was one second, the first window would be from t=0.5 to t=1.5; the second window would be from t=1.5 to t=2.5; etc (the first window does not start at t=0 to allow for a lead in portion that may be blended later—see discussion below). For a particular window, the velocity of each joint is calculated throughout the window 302 and the velocities are filtered to remove noise 304. Then the smallest velocity is identified and a segment boundary inserted 306. As discussed previously, the point where the contact between the character and the environment is moving the slowest is the point where the contact force is the highest. Finally, if there are still unprocessed windows, the remaining windows are processed in the same manner 308.

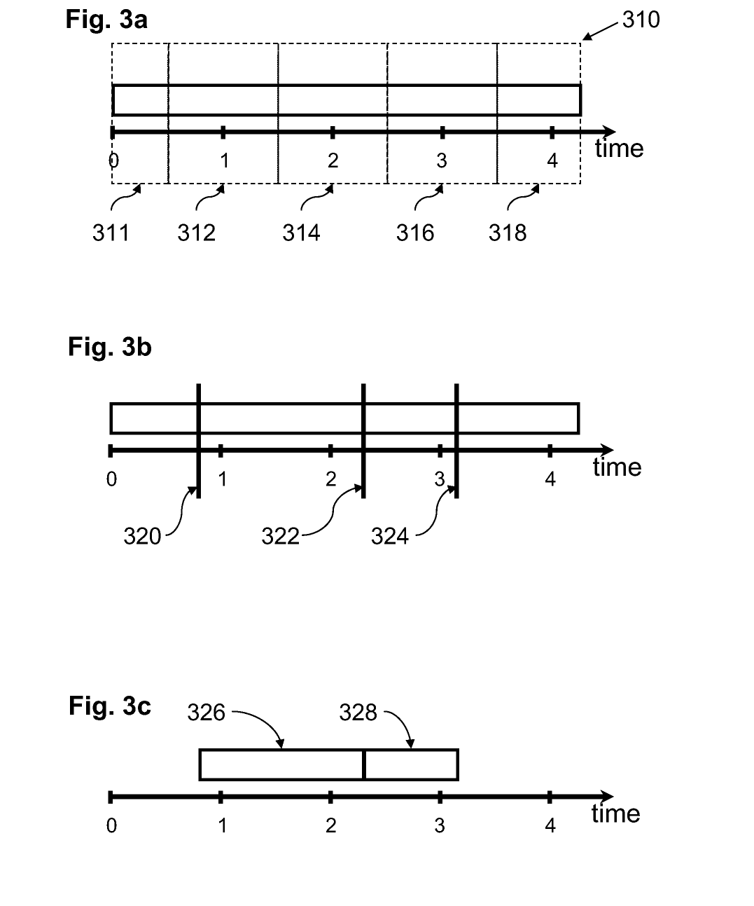

FIGS. 3a, 3b, and 3c show exemplary graphical representations of the steps in the segmentation process of the animation system of the present embodiment. Referring to FIG. 3a, the entire animation clip 310 is just over four seconds long. In the preferred embodiment, the first half of a second of the clip, the lead in portion 311, is ignored. Ignoring some portion at the beginning of the clip allows some lead in time for blending that may occur later. Then the clip is split into windows: Win1 312, Win2 314, and Win3 316. In this example, as in the preferred embodiment, the window size is one second. Finally, any remaining portion of the clip that is less than the window length, the lead out portion 318, is ignored for the same reason as the lead in portion 311. Though the lead in portion 311 is discussed above as being a half of a second, any lead in time, including none, would also work. In an alternative embodiment the lead in portion 311 length is adjustable by the user.

Each window is analyzed and each joint's velocities are calculated to determine which joint in the window has the lowest velocity at what time that joint is the slowest. At the point where the slowest joint has the lowest velocity, a segment boundary is inserted. FIG. 3b shows the same clip with the segmentation boundaries inserted. The first segmentation boundary 320 occurred at about t=0.8. Again, the first segmentation boundary 320 represents the place in Win1 312 where the velocities of the joints were the smallest. Likewise, the second segmentation boundary 322 occurs at about t=2.25 and the third segmentation boundary 324 occurs at about t=3.1. In this example, the portion before the first segmentation boundary 320, t=0 to about t=0.8, and after the third segmentation boundary 324, t=3.1 to about t=4.3 are ignored.

FIG. 3c, shows the final two segments after the segmentation process completes. Segment 1 326 is a little over a second long running from about t=0.8 to about t=2.25 and Segment 2 328 is about a second long running from about t=2.25 to about t=3.1. Because there is one segment boundary for each window and it takes two segment boundaries to create one segment, there will be one less final segments than there were windows. Therefore, by adjusting the window size smaller there will be more final segments and conversely, by adjusting the window size larger, there will be fewer final segments. Though the window size is discussed herein as being one second, any other window size is intended to be within this disclosure. In an alternative embodiment the window size is adjustable by the user.

### Joining Segments

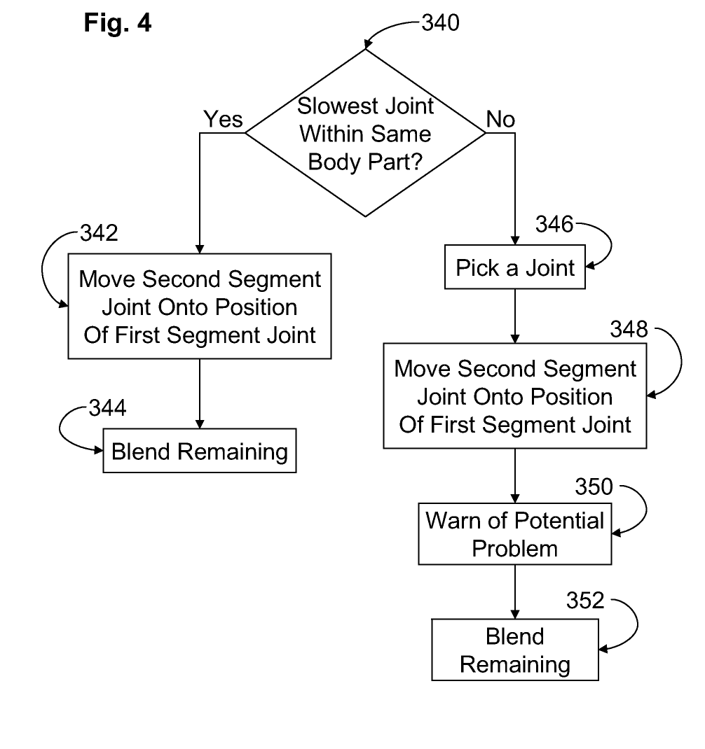

FIG. 4 shows a flow chart of the segmentation joining process of the animation system of the present embodiment. Once segments have been formed, the user may assemble the segments to create new animations. For simplicity, the segmentation process is discussed as only joining two segments together; however, this disclosure is intended to include joining an unlimited number of segments together.

Recall that each segment boundary was inserted at the point where the slowest joint had the lowest velocity; therefore, it is assumed this joint may be in contact with the environment. This joint is the contact joint. First, the system determines if the contact joint of the first segment is within the same body part as the contact joint of the second segment 340. If the contact joint at the end of the first segment and the contact joint at the beginning of the second segment are both in the same body part (e.g. foot, hand, etc), then the second segment is rigidly moved such that the position and orientation of that body part at the beginning of the second segment is the same as at the end of the first segment 342. To rigidly move something means to move it without any deformation. Finally, the remaining joints are blended together using motion blending 344. However, if the contact joint is not in the same body part, any joint can be used 346 as the contact joint. In the preferred embodiment, the hip joint is used. Again, the second segment is rigidly moved such that the position and orientation of the body part containing the contact joint at the beginning of the second segment is the same as at the end of the first segment 348. Next, the user is warned that the join may not look very good because the slowest joint was not in the same body part for both segments 350. Finally, the remaining joints are blended together using motion blending 352.

In the preferred embodiment, the root's position is linearly blended over a small time period (e.g. one second). The root is generally the center of the character (e.g. the waist); however, it may be another joint. Then the joint angles, represented as quaternions, are blended using spherical linear interpolation (“SLERP”). In an additional embodiment, a different scheme could be used that keeps the contacts as stationary as possible. Normally, joints are represented relative to the root of the skeleton; however, the joints could be represented relative to the contact joint. The contact joint would then become the new root joint of the character. Then motion blending would be performed as before.

### Assembling a New Clip

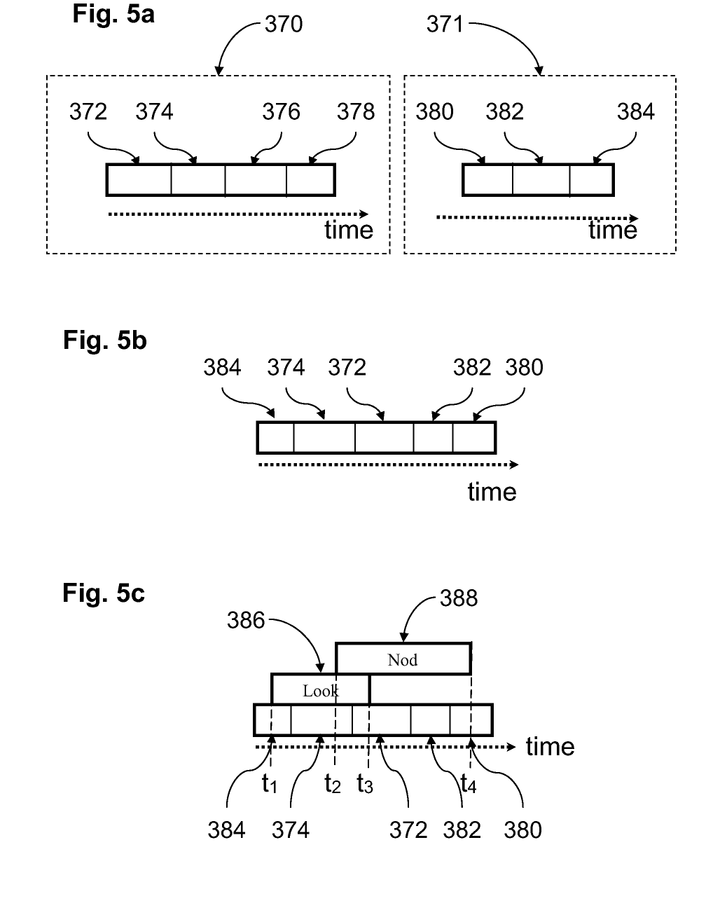

FIGS. 5a and 5b show exemplary graphical representations of the assembling a new clip of the animation system of the present embodiment. Referring to FIG. 5a, the clips have already undergone the segmentation process. The first clip 370 is made up of four segments: A1 372, A2 374, A3 376, and A4 378. The second clip 371 is made up of three segments: B1 380, B2 382, and B3 384. FIG. 5b shows the new clip made up of segments from the first 370 and second 371 clip. The new clip is made up of: B3 384, A2 374, A1 372, B2 382, and B1 380.

### Editing an Animation

A “modifier” is used to edit animations. The modifier takes into account the state of the character and produces a modified state for the character. Modifiers are defined procedurally using pre-defined “primitives”. The primitives are functions. In the preferred embodiment, modifiers are specified using the C++ programming language. However, several alternative embodiments exist, such as specifying modifiers using scripting languages, other programming languages, with a WYSIWYG graphical interface, etc. In the preferred embodiment, two primitives are provided. The first orients part of the character in a particular direction, and the second puts part of the character in a particular place.

FIG. 5c shows an exemplary graphical representation of adding a modifier to a new clip of the animation system of the present embodiment. In this example, modifiers are used to make a character look at the camera and nod its head. The modifier takes the clip as input. The primitive to orient part of the character in a particular direction is invoked to orient the head so it is looking at the camera 386. Further, if the character had eyes, the same primitive would be invoked to orient the eyes so they were also looking into the center of the camera lens. Then the primitive to put part of a character in a particular place is invoked to move the head up and down 388. Again, if the character had eyes, the same primitive would be invoked to move the eyes up and down with the head. In this example the orient primitive ran from t1 to t3 and the move primitive ran from t2 to t4; therefore, from t2 to t3 the character would be both orienting its head towards the camera and moving up and down. By using modifiers on multiple body parts and overlapping multiple modifiers, very complex movements can be created. In the preferred embodiment, the user may indicate the time span over which the primitive will run.

It is undesirable to introduce discontinuities into the animation when a modifier begins and ends. Thus, the system smoothes the edited degrees of freedom (DOF) into the motion at the beginning of the modifier, and smoothes the edited DOF out of the motion at the end of the modifier using motion blending. The system uses a short time period after the modifier's start time as the blend-in period, and a short time period before the modifier's end time as the blend-out period. In the preferred embodiment, these parameters are customizable by the user. In an alternative embodiment the blending method is also customizable by the user.

Stabilizing a Character's Contacts with the Environment

Additionally, the system can stabilize a character-environment contact so that it does not slide. Sliding is a visual artifact of joining and blending two clips together where a character is supposed to have a stationary contact between the character and the environment; however, because of the joining, it appears the character slides.

This method can work with any of the character's joints, but in the preferred embodiment, the user picks an end effector (i.e., the end of a joint chain). The user then marks the frame at which contact between the end effector and the environment begins and the frame at which it ends. In an alternative embodiment, these steps could also be automated by finding joints that are in contact with the environment and marking the start and end frames.

With the joint that is contacting the environment identified (the contact joint) and the range of frames over which the contact is occurring identified (the contact range), the animation is edited so that the contact joint is stationary (i.e., planted) at a target position during the contact range. During a short time period before the contact range (blend-in period), the trajectory of the joint is smoothly changed so it hits the target position at the start of the contact range. During a short time period after the contact range (the blend-out period), the joint is smoothly moved back onto its original trajectory. In the preferred embodiment, the user determines the length of the blend-in and blend-out periods.

In the preferred embodiment, the position and orientation of the end effector in the middle frame of the contact range is used as the target position. In an alternative embodiment, the user could specify the target position and orientation of the end effector. For each frame in the blend-in period, the desired position of the joint is calculated by performing a blend between the joint's current position and the target position. The current position has full weight at the start of the blend-in period, and the target position has full weight at the end. In the preferred embodiment, linear blending is used.

Inverse kinematics (“IK”) is used to place the joint at the desired position. IK takes a joint hierarchy and a desired position for a particular joint, and computes the joint angles necessary to place the joint at the desired position.

For each frame in the contact range, IK is used to place the joint at the target position. Then for each frame in the blend-out period, the desired position of the joint is calculated by blending between the joint's current position and the target position, where the target position has full weight at the start of the blend-out and zero weight at the end, and the current position has zero weight at the start and full weight at the end. We again use IK to plant the joint there.

If the motion data is noisy, one may wish to filter it before applying this technique, since this method may be adversely affected by outliers.

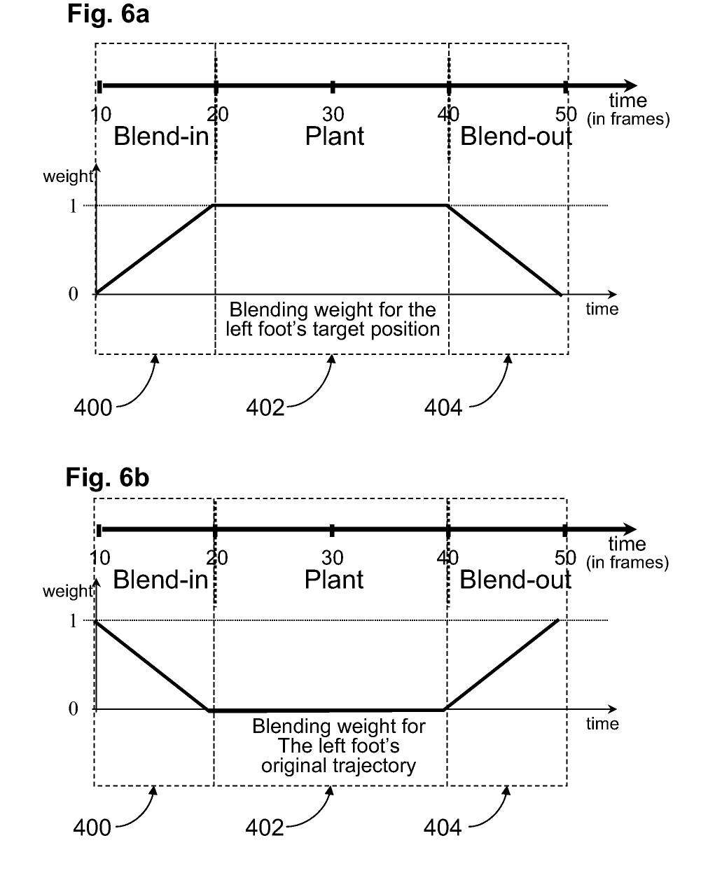

FIGS. 6a and 6b show exemplary graphical representations of the stabilization method of the animation system of the present embodiment. The user desires the character's left foot to be planted at frames 20-40 402. The user chooses frames 10-20 400 as the blend-in period, and 40-50 404 as the blend-out period. As in the preferred embodiment, linear blending is used to compute the position of the foot at each frame, though other blending schemes could be used as well.

It is desirable for the foot to move slowly to the target position during the blend-in period 400, stay planted at the target position during the contact range 402, and slowly move back to its original trajectory in the blend-out period 404.

The graphs show the blending weights that accomplish this. FIG. 6a depicts the blend weight given to the foot plant's target position. During the blend-in period 400, the weight linearly increases until it reaches full weight. During the blend-out period 404, the weight decreases linearly back to zero. FIG. 6b depicts the blend weight given to the foot plant's original trajectory. Because the blend weights must sum to one at all frames, the weight given to the original trajectory at every frame is one minus the weight given to the target position. During the blend-in period 400, the weight decreases linearly until it reaches zero. During the blend-out period 404, the weight increases linearly until it reaches full weight.

### Semantic Constraint System for Virtual Objects

Objects in a 3D scene often have geometric relationships to other objects. For example, a cup can sit on a table, which can rest on a rug. When users move objects in the scene, methods exist to determine where to move other objects so that these geometric relationships are maintained.

Such methods usually work by referring to a list of geometric relationships. The artist creating a scene defines the list of relationships that need to be enforced, and the system uses the list to compute a configuration of objects that satisfies those relationships. For instance, if a table moves, a cup lying on the table is also moved, provided a cup-table relationship is in the list.

The main flaw in such an approach is that all possible object relationships must be enumerated for the system to work properly. Because the list of relationships is strictly interpreted, current methods lack generality. To address this limitation, a method is disclosed for generalizing geometric relationships through natural language processing. Natural language processing techniques are used to automatically generalize the relationship between a “cup” and a “table” to a “cup” and a “counter”, a “horizontal surface”, a “kitchen table”, etc. Put differently, users can specify a rich family of relationships to a particular object through a single example. Besides saving users the time and effort required to enumerate specific relationships, this also makes it easier to include new types of objects, because the user may not need to specify new relationships if they are already covered by previous examples.

### Representing Constraints

In the preferred embodiment, constraints between objects are defined using anchors and receivers. An anchor is a right-handed coordinate system (a point with three orthogonal unit direction vectors x, y, and z, where z is the positive cross-product of x and y). A receiver is an oriented surface. An anchor that is constrained to a receiver must lie on the receiver's surface, and its y vector must have exactly the opposite orientation of the receiver's normal.

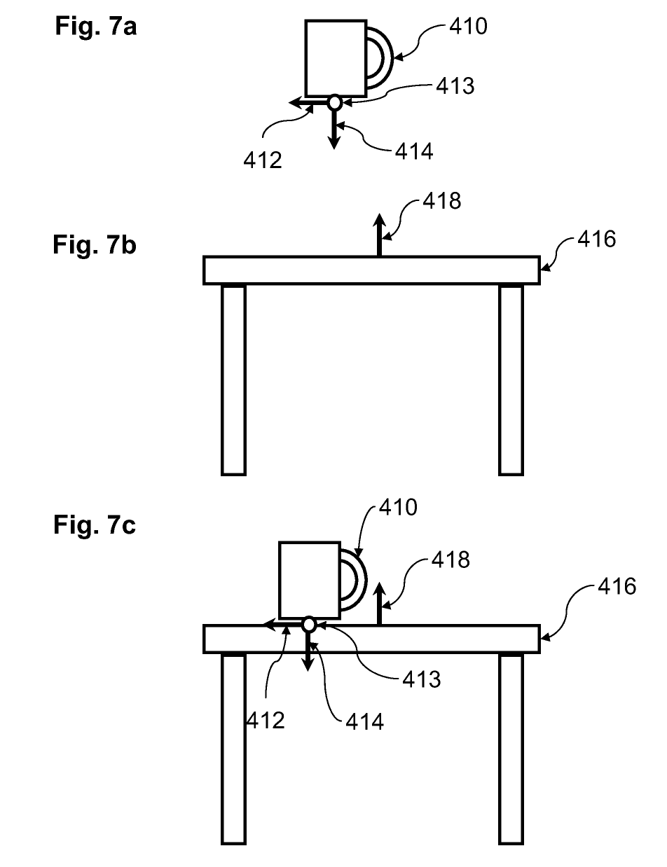

FIGS. 7a, 7b, and 7c show exemplary graphical representations of the constraint system of the animation system of the present embodiment. FIG. 7a shows a side view of a 3D model of a cup 410. The anchor 415 is defined on the bottom so that the y vector 414 faces downward, the x vector 412 faces to the left, and the z vector (not shown) comes out of the page. FIG. 7b, shows a side view of a 3D model of a table 416. The receiver is defined on the table top surface. The receiver's normal faces upward 418. Finally, FIG. 7c shows the cup 410 on the table 416 after cup's anchor 415 has been constrained to the table's receiver 418 forcing the cup to sit on the table, since the cup's y vector 414 must face in the opposite direction from the table top's normal vector 418.

### Labeling Objects

Receivers must be labeled with their types (e.g., “sofa”, “tabletop”). Anchors must be labeled with the type of receiver to which they can be constrained, the connecting type (e.g., “horizontal surface,” “tabletop”).

Natural language processing software is used to generalize the labels. Therefore, it is important that the software recognize the labels (i.e., the labels need to use natural language and be in the database the software uses). The preferred embodiment uses Wordnet™, though other packages are available.

To check whether an anchor and a receiver can be constrained to each other, the system enters the anchor's connecting type into a natural language processing package to check for a match between it and the receiver's label. A match may be an exact word match, or may be a match through a synonym, hyponym, or hypernym. For example, “tabletop” trivially matches to “tabletop”, but also matches to the hyponym “countertop” and the hypernym “work surface.” Anchors and receivers that match are said to have a constraint relationship.

### Defining Constraints

Once objects are defined with anchors and receivers, users can assemble 3D environments by simply “snapping” objects together. When a user moves an object, the system checks each anchor on the moved object for nearby receivers on other objects, and checks each anchor on other objects for nearby receivers on the moved object. The system initializes a constraint between an anchor and a receiver that are nearby and have a constraint relationship. In the preferred embodiment, to break the constraint, the user simply moves the objects apart. In an alternative embodiment, the user could select an object and turn off snapping on an object by object basis. Note that to initialize the constraint, the objects do not have to be precisely aligned. They simply need to be close together.

In the preferred embodiment, a receiver is defined to be nearby an anchor if the distance between the anchor's point and the closest point on the receiver's polygon to the anchor is less than a system-defined maximum distance threshold (20 centimeters). In alternative embodiments, one could use methods that more accurately compute the distance between two geometrical objects. In yet another embodiment, the user could define the maximum distance threshold.

### Satisfying Constraints

Once constraints are defined, the system solves for a configuration of objects that satisfies the constraints as closely as possible. Each object's position and orientation are unknown variables. In addition, objects may have parameters that control the object's shape (e.g., a parameter may control the height of a table object). Such parameters are also unknown variables. Basically, this is an optimization problem. Because the new configuration should differ as little as possible from the current configuration, the objective function constrains each unknown variable to be as close to its current value as possible. This optimization problem can be formulated as a quadratic programming problem, for which solution methods are well known.

### Editing a Character's Foot Plants

A commonly desired feature in character animation software is the ability to edit the path a character takes (e.g., edit a motion where the character is moving straight ahead so that the character is turning right instead). However, path editing can cause objectionable visual artifacts, such as making the contacts the character makes with the environment slide.

The more drastic the path edit, the more likely it is to cause visual artifacts. The system needs to distribute the edits users make over the whole path. Since edits are locally minimized, visual artifacts are generally less likely. The method requires little computation time, making it suitable for real-time 3D graphics applications, such as video games.

A character's path is represented as an ordered set of contacts with the environment (e.g., footsteps, hand contacts, etc.). For each contact, the global position and orientation of the part of the character touching the environment is recorded. In the preferred embodiment, the character is assumed to have a skeleton, so we record the position and orientation of the bone contacting the environment. The user edits the character's path by changing the position and orientation of some or all of the contacts.

The system then computes new positions and orientations for all of the contacts that the user did not change. Then, the system edits the character's original motion so that each contact meets its new position and orientation.

There are infinitely many ways the system can position and orient the contacts the user did not change. The system seeks the solution that makes the new animation look as much like the original as possible, because small changes are less likely to introduce visual artifacts into the animation.

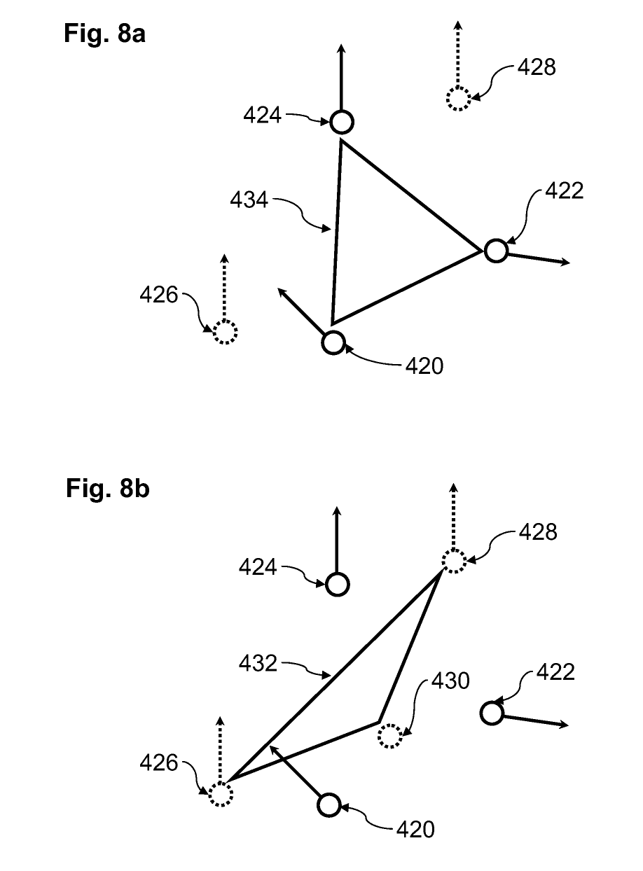

FIGS. 8a and 8b show exemplary graphical representations of editing a character's foot plants of the animation system of the present embodiment. Herein, the contacts the user modified are called the “fixed” contacts, and the contacts the user did not modify are called the “free” contacts. It is desirable to place the free contacts such that the character's motion changes as little as possible.

One measure of change is path deformation. Herein, the original position of the ith foot plant is referred to as Pi, and the new position to solve for is referred to as Pi*. The system can measure local deformation of the path around the ith foot plant by computing how different the triangle created by Pi−1, Pi, and Pi+1 is from the triangle created by Pi−1*, Pi*, and Pi+1*. It is desirable to minimize this difference.

FIG. 8a illustrates a simple example on a path with only three foot plants. The three foot plants are marked 420, 422, and 424, respectively. A user moves and rotates the first foot plant to the location and orientation marked by 426, and the third foot plant to the location and orientation marked by 428. The system needs to solve for where the second foot plant 422 should be positioned (i.e., the new location and orientation of the second foot plant) such that the first triangle 434 created by 420, 422, and 424 is as similar as possible to the second triangle 432 created by 426, 428, and 430.

This is formulated as a constrained optimization problem. The objective function tries to keep the triangle formed by Pi−1*, Pi*, and Pi+1* as similar as possible to the triangle formed by Pi−1, Pi, and Pi+1, subject to satisfying the fixed contacts. Though there are other ways to formulate the objective function, only two ways are described herein.

In the preferred embodiment, the system measures the change between the triangles as the change in area. Referring back to FIGS. 8a and 8b, the system solves for the position of 430 such that the area of the second triangle 432 is as close as possible to the area of the first triangle 434.

Let T be the triangle formed by Pi−1, Pi, and Pi+1, and let T* be the triangle formed by Pi−1*, Pi*, and Pi+1*. Let A(T) be the area of triangle T, and A(T*) be the area of triangle T*. In the objective function, we want to minimize:

∥A(T*)−A(T)∥

Each set of three successive foot plants has one corresponding constraint term in the optimization (e.g., if there are four foot plants, there will be two terms: one for foot plants 1, 2, and 3, and the second for foot plants 2, 3, and 4).

In an alternative embodiment, the system measures the change between the triangles as the change in angles. Again referring back to FIGS. 8a and 8b, the system solves for the position of 430 such that the angle at 426 is as close as possible to the angle at 420, the angle at 430 is as close as possible to the angle at 422, and the angle at 428 is as close as possible to the angle at 424.

In the general case, the corresponding angles of the triangles should be as close as possible (i.e., the angle at Pi should be as close as possible to the angle at Pi*). Therefore, it is desirable to minimize the following three terms in the objective function:

∥(P2−P1)·(P3−P1)−(P2*−P1*)·(P3*−P1*)∥

∥(P3−P2)·(P1−P2)−(P3*−P2*)·(P1*−P2*)∥

∥(P1−P3)·(P2−P3)−(P1*−P3*)·(P2*−P3*)∥

In yet another embodiment, a combination of the embodiments is used to calculate the position.

### New Foot Plant Orientations

The system also adds terms to the objective function that try to minimize the change in each free contact's orientation. The orientation of each contact is defined relative to the vector from the previous contact's position to the next contact's position. The system measures the orientation difference between the orientation of the current contact and this vector. To minimize the change in orientation of each contact, we minimize the following term in the objective function for each contact:

∥Θi*−Θi∥

The first term (Θi*) is the new relative orientation of the ith contact, and the second term (Θi) is the original relative orientation of the ith contact.

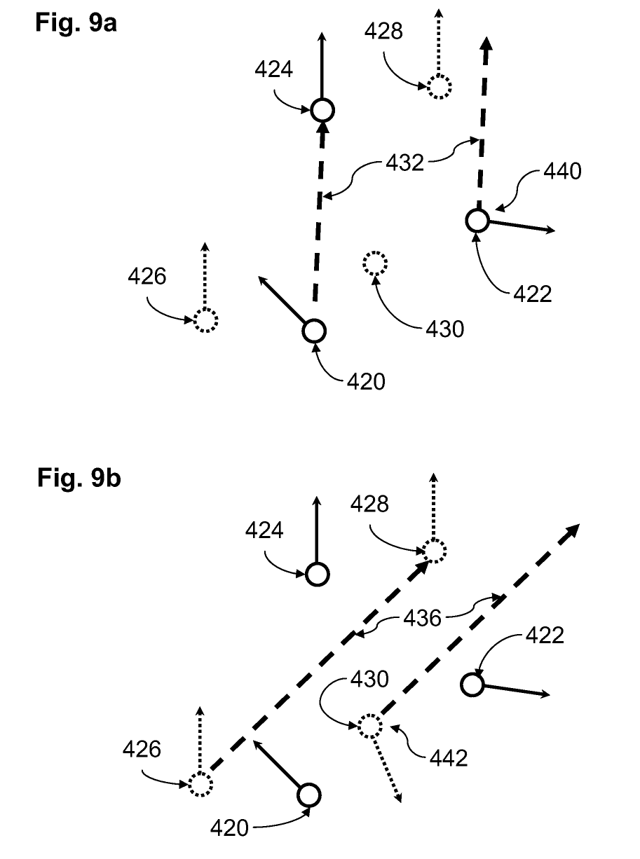

FIGS. 9a and 9b, show exemplary graphical representations of minimizing the orientation change in each free contact of the animation system of the present embodiment. Referring to FIG. 9a, imagine a vector 432 that runs from the location of the first foot plant 420 to the location of the third 424. The system translates this vector 432 so that it starts at the location of the second foot plant, and define angle G1 440 as the angular difference between this vector 432 and the orientation of foot plant 2 422. Referring to FIG. 9b, angle G2 442 is defined analogously by imagining a vector 436 from 426 to 428 and translating that vector 436 from 426 to 430. The optimization will try to keep angles G1 440 and G2 442 as equal as possible.

### Optimization

To solve for the new positions and orientations of the free contacts, the system minimizes the objective terms previously described. These terms try to minimize the change introduced into the character's motion. The system performs the minimization subject to meeting the positions and orientations of the fixed contacts.

Although there are a great variety of solution methods for this type of constrained optimization, in the preferred embodiment, the system uses constrained gradient descent. In an alternative embodiment, sequential quadratic programming is also an effective solution strategy.

### Motion Editing

After computing a new position and orientation for every contact, the original motion is edited so that the contacts are at the new positions and orientations.

For every contact, the system computes the rigid body transformation required to transform the position and orientation of the contact in the original motion to the new position and orientation. Each contact occurs at a particular time in the animation, so the system can build a function f of time that yields the rigid body transformation needed to apply to the character at a particular time using scattered data interpolation.

In the preferred embodiment, the system uses piecewise linear interpolation with spherical linear interpolation for the orientation components of the transformations. However, one can use a variety of scattered data interpolation methods.

The system can then sample f at every frame in the animation, and apply the transformation f yields to the root bone's position and orientation. This will rigidly move the character so that each contact meets its new position and orientation. However, this method can make the character's contacts with the environment slide. The solution to this is disclosed above (see Stabilizing a Character's Contact with the Environment).

### Automatic Character Animation Retargeting

Imagine a 3D humanoid character named Betty. The goal is to make Betty do jumping jacks. Betty could be animated using techniques known in the art such as keyframing or motion capture, but these techniques are usually difficult and expensive.

Imagine though that another 3D humanoid character, Abby, is already doing jumping jacks. Can Abby's animation data be used on Betty? In general, the answer is no. Animation data is tied to a particular skeleton, so unless Abby and Betty have exactly the same skeleton, Abby's animation data cannot be used on Betty. Character skeletons are not standardized (and in fact tend to differ widely), so two characters will usually have different skeletons.

The following disclosure provides for mapping one character's animation data (“source”) onto another character (“target”). Given Abby's animation data, this system can automatically make Betty do jumping jacks. The system described herein is fast, making it suitable for real-time 3D graphics applications, such as video games.

Other methods attack the same problem (commonly referred to retargeting in the art). These methods fall into two categories. The first category only works if the source and target skeletons are structurally identical. The bones can differ in length, but otherwise must be identical. Since character skeletons usually differ structurally as well as proportionally, these methods tend to have limited applicability. The second category forces someone to manually specify corresponding bones between source and target. Though very slow and cumbersome, this is feasible for a few characters, but it does not scale well. Furthermore, these techniques cannot be used to retarget animation on-the-fly.

The system disclosed first automatically determines the bones in the source character that map to bones in the target character and then computes the target animation data from the source animation data.

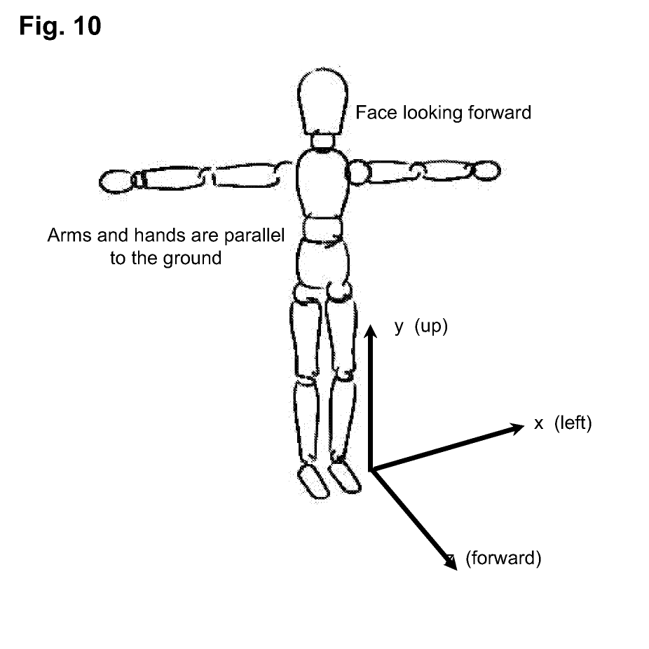

The system requires a source character pose and target character pose that are known to correspond. In the preferred embodiment, the system uses the source's and target's T-poses. FIG. 10 shows a graphical representation of a character in a T-Pose of the animation system of the present embodiment. The T-pose is a canonical pose known in the art in which the character's legs are together and the arms are stretched out on either side so they are parallel to the floor. The system requires that in the T-pose, the up direction is in the positive Y-direction in the global coordinate frame, the character is facing the positive Z-direction, and the positive X-direction is to the character's left side. The system additionally requires that the skeleton's root bone is the hip bone. Further, the system requires that both characters have corresponding parts. For example, if the source character is a humanoid, the target should also have two arms, two legs, and a torso; however the source's body parts can differ radically from the target's body parts in size and/or appearance. For example, the source can be a human, and the target can be a tiger, where the target's “arms” are the tiger's front legs, and the target's “legs” are the tiger's back legs. Without this requirement, it is unclear how the source motion should map to the target motion.

### Mapping the Source Character's Bones to the Target Character

The first step is to find correspondences between the source character's and the target character's bones. For example, match the bone in the upper leg of the source to the bone in the upper leg of the target. It is common practice in the art to label the bones with descriptive names like “lower_left_arm”. These names are not standardized and therefore, one cannot generally find corresponding bones using exact string matching. However, there are some naming conventions that are generally observed. For example, “left” and the letter “L” are both commonly used to denote the left side of the character's body. The upper bone of the character's leg is usually called “femur”, “upperleg”, or “upper_leg”. In the preferred embodiment, the system uses these naming conventions to match bones like “left_upperleg” and “LFemur”. In an alternative embodiment, the system uses natural language processing to find matches. Natural language processing packages can identify words that are synonyms, like “upper leg” and “femur”.

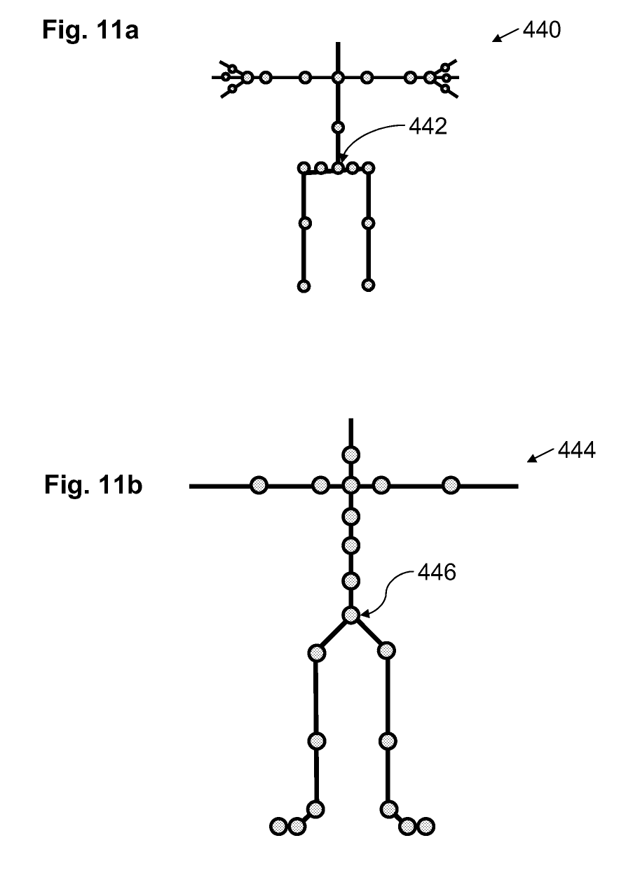

The system iterates over each bone in the target and tries to find a matching bone in the source. Note that because the source and target can have different numbers of bones, some of the target character's bones may not have any matches. For example, the skeletons shown in FIGS. 11a and 11b have different numbers of bones. Also, the source 440 has hands and no feet, while the target 444 has feet but no hands. Since the system requires that the source's and target's root bones be the hip bones, the target's root bone 446 always matches the source's root bone 442.

For clarity of explanation, for each target bone i in the target skeleton, the corresponding bone in the source skeleton will be denoted as m(i). Again, not every bone in the target skeleton may have a corresponding bone in the source skeleton and vice versa.

Mapping Animation Data Defined on the Source Character onto the Target

Next, the system maps the animation data defined on the source character onto the target character. The system iterates over each frame (i.e., pose) of the animation, determining an orientation for each of the target's bones, and the root position of the target at each frame. The system specifies the orientations of bones in the global coordinate frame.

Recall that each joint has three rotational degrees of freedom (DOF), and that the root additionally has three translational DOF. Hence, the root has six DOF, and all other bones have three DOF. The problem is then, given the position of the root bone and the orientations for every bone in the global coordinate frame on the source character, to find the root position and orientations for the bones on the target character.

The system computes the global orientations of the source character in its T-pose. The orientation is known for every bone in the source character (call it x) and that bones orientation in the frame that needs to be mapped to the target (call it y). The rotation matrix T can be calculated such that Tx=y. In effect, T is the rotation that takes the neutral orientation of a bone in the T-pose and transforms it to the current orientation in the source character.

Next, the system computes the global orientation of the target bones in the T-pose. The system uses the rotation matrices T that were computed for the source character to map the DOF.

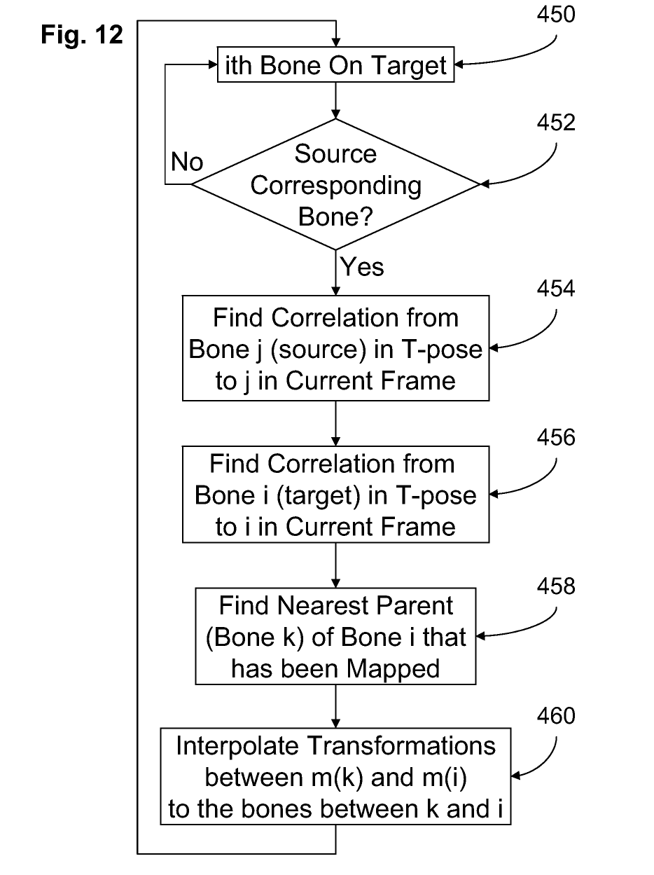

FIG. 12 shows a flow chart of the bone retargeting system of the animation system of the present embodiment. A depth-first traversal of the bones in the target character is completed. Since the root bones are assumed to be in correspondence, the system copies the position and orientation of the root bone to the target. For every other bone i in the target character 450, if there is no corresponding bone m(i) in the source character the system skips that bone to traverse its children 452. If bone i has a corresponding bone m(i) in the source character, the system looks up the rotation matrix Tₘ₍ᵢ₎ that was computed in the previous step. Recall that this is the rotation matrix that takes the bone in the T-Pose (in the source character) and rotates it to the desired orientation (in the current animation frame) on the source character 454. The system applies the same matrix to the T-Pose orientation of the bone i: Tₘ₍ᵢ₎xᵢ=yᵢ. This gives the orientation of bone i in the global coordinate frame 456. This procedure might have skipped some bones that are ancestors of the bone i that was just retargeted. To handle the skipped bones, the system finds the closest ancestor of i that was able to map using a direct correspondence (call that bone k) 458. Note, since the root bone is the first bone in the skeletal hierarchy and is always mapped, the ancestor can always be found. The system interpolates the rotations Tₘ₍ₖ₎ and Tₘ₍ᵢ₎ to get the global orientations of the bones between k and i 460.

This interpolation can be done in various ways. In the preferred embodiment, the system uses spherical linear interpolation as a function of the index of the bone in the chain from i to k.

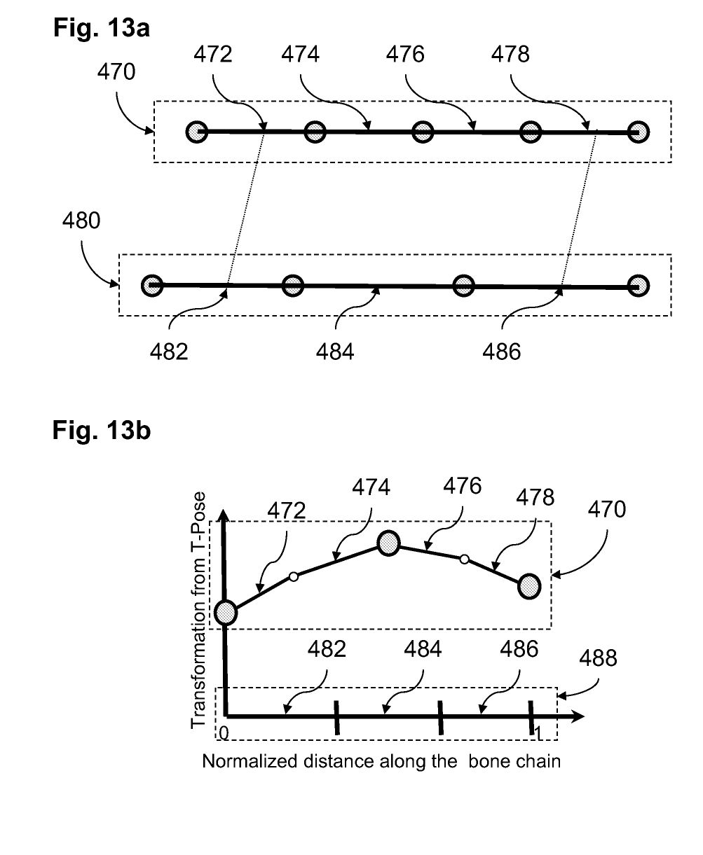

FIGS. 13a and 13b show graphical representations of an alternative method to interpolating the rotations for bones of the animation system of the present embodiment. Referring to FIG. 13a, the target chain 470, has bone k 472 which corresponds to source chain 480 bone m(k) 482. Additionally, the target chain 470, has bone i 478 which corresponds to source chain 480 bone m(i) 486. However, target chain 470 has bone 474 and bone 476 that have no direct correlation in the source chain 480. In this alternative embodiment, the system could take all the transformations for the bones between Tₘ₍ₖ₎ and Tₘ₍ᵢ₎ and parameterize them with the length of the bones along the chain. Referring to FIG. 13b, when the system normalizes this parameter by the total length 488, a function which is Tₘ₍ₖ₎ at length 0 and Tₘ₍ᵢ₎ at length 1 is created. Now there are data points that belong to this function for the bones between m(k) and m(i). The system then does the same parameterization for the intermediate uncorrelated bones (474 and 476) between k 472 and i 478 in the target chain 470. This reduces the problem to scattered data interpolation. Now the system fits a function to the points. The system takes the target's bone chain, computes the length ratios according to the same calculation, and uses the function to determine the rotation to apply to each target bone between k 472 and i 478 that was skipped. This provides the necessary global orientation of the two intermediate uncorrelated bones (474 and 476).

During this process, bones in the target skeleton having no corresponding bone in the source skeleton and with no descendant having a corresponding bone in the source, will not be processed. The system sets the relative orientation (i.e., orientation relative to its parent bone) of each of these unprocessed bones to its relative orientation in the T-pose.

### Fixing the Target Character's Footsteps

The system now has orientations for all of the bones; however, the system still needs to fix the target character's contacts with the environment, which may slide as a result of the retargeting procedure.

In order to fix any sliding problems, the system finds the height of the source skeleton's hip and the height of the target skeleton's hip using the T-poses of the source and target character. Dividing the source's hip height by the target's hip height approximates the ratio of the length of the source's legs to the length of the target's legs.

The system represents the foot plant locations of the source's motion relative to the source's starting point. Then the system scales the hips and foot plants by multiplying their position on the ground plane by the scale factor. Finally, the system performs inverse kinematics to plant the target's feet on the calculated position.

Those with skill in the arts will recognize that the disclosed embodiments have relevance to a wide variety of areas in addition to those specific examples described below.

All references, including publications, patent applications, and patents, cited herein are hereby incorporated by reference to the same extent as if each reference were individually and specifically indicated to be incorporated by reference and were set forth in its entirety herein.

What is claimed is:

1. A method for dividing an animation clip, the method comprising:
receiving a character from a user, said character having at least one joint;
receiving an animation from said user;
receiving a window size;
segmenting said animation into at least one window, each said window being of said window size, said segmentation comprising:
calculating a velocity for each said joint in said animation;
filtering said velocities;
inserting a segment boundary into each said window where said velocity is the lowest for said window.
